(19) United States
(12) Patent Application Publication
(10) Pub. No.: US 2014/0064506 A1
(43) Pub. Date: Mar. 6, 2014

(54) ELECTRONIC DEVICE AND METHOD FOR BLOCKING ECHO GENERATION BY ELIMINATING SOUND OUTPUT FROM SPEAKER

(71) Applicant: Samsung Electronics Co., Ltd., Gyeonggi-do (KR)

(72) Inventor: Hee-Jun RYU, Gyeonggi-do (KR)

(73) Assignee: Samsung Electronics Co., Ltd., Gyeonggi-do (KR)

(21) Appl. No.: 14/013,712

(22) Filed: Aug. 29, 2013

(30) Foreign Application Priority Data
Aug. 31, 2012 (KR) 10-2012-0096411

(51) Int. Cl. G10K 11/16

(52) U.S. Cl. CPC G10K 11/16
USPC 381/66

(57) ABSTRACT

A method for operating an electronic device including a first microphone and a second microphone to block the echo generation the electronic device is operated in a loudspeaker mode. The method includes: determining whether a sensor located within a predetermined range from the second microphone has sensed a peripheral object; blocking an operation of the second microphone when the sensor has sensed a peripheral object; and blocking echo generation by eliminating a sound that is output from a speaker and input to the first microphone.

### CLAIM OF PRIORITY

This application claims priority under 35 U.S.C. §119 from an application filed in the Korean Intellectual Property Office on Aug. 31, 2012 and assigned Serial No. 10-2012-0096411, the contents of which are incorporated herein by reference in its entirety.

### BACKGROUND

1. Field of the Invention

The present disclosure relates to an electronic device and method for blocking echo generation in an electronic device. More particularly, the present disclosure relates to an electronic device and method for blocking echo generation in an electronic device capable of operation in a loudspeaker mode with two microphones.

2. Description of the Related Art

In an electronic device that is provided with two microphones, there are some issues regarding echo generation that adversely impact the sound quality of the electronic device. Conventional attempts to reduce echo generation were based on utilizing a volume difference between the primary microphone and the secondary microphone to block an echo generated in the electronic device.

However, in an electronic device operating in a loudspeaker mode, the electronic device often operates with a secondary microphone placed on a floor, and thus an echo is occasionally generated because a sound output from a speaker is input to the secondary microphone and is again output through the speaker. In other words, the purpose of using a dual microphone is not accomplished because the sound output from the speaker of the electronic device is input to the secondary microphone through the floor.

Also, in an electronic device operating in a Video Telephony (VT) mode, when a user is holding (or has attached to the clothing or body) a secondary microphone, an echo is generated because a sound output from a speaker is input to the secondary microphone and is again output through the speaker.

The echo generation can provide a great deal of dissatisfaction with the electronic device, as some user indicate a level of physical discomfort listen to echo generated sounds.

Therefore, there is an urgent need to develop an apparatus and method that can block an echo from being generated in an electronic device provided with dual microphones.

### SUMMARY

The present invention addresses at least some of the above issues and/or disadvantages and to provide at least the advantages below. Accordingly, the present invention provides an apparatus and method for blocking an echo, which may be output through a speaker, by automatically blocking the operation of a secondary microphone in the electronic device according to certain conditions. More particularly, the present invention provides an apparatus and method for blocking an echo output through a speaker by controlling the operation of a second microphone via proximity detection. A proximity sensor can be used for proximity detection.

In a non-limiting example of the practicing the present invention, an optical proximity sensor maybe utilized.

The present invention also may provide an apparatus and method for maximizing utilization of dual microphones by enabling the operation of a second microphone according to a select operation mode or modes, without uniform operation of the second microphone in all modes.

According to an aspect of the present invention, a method for operating an electronic device having a first microphone and a second microphone may include: determining whether a sensor located within a predetermined range from the second microphone has sensed a peripheral object; blocking an operation of the second microphone when the sensor has sensed a peripheral object; and blocking echo generation by eliminating a sound that is output from a speaker and input to the first microphone.

The method may further include confirming that the electronic device is operating in any one of a first mode and a second mode.

For, example, the first mode may be a loudspeaker mode, and the second mode may be a Video Telephony (VT) mode.

In a non-limiting example, the sensor may be an optical proximity sensor. The operation of determining whether the sensor located within a predetermined range from the second microphone has sensed a peripheral object may include: emitting infrared Light Emitting Diode (LED) light by the sensor; and determining whether the sensor has sensed infrared LED light reflected by the peripheral object. An artisan should understand and appreciate that the use of infrared light is only illustrative of one way the invention can be practiced.

Blocking the operation of the second microphone when the sensor has sensed a peripheral object may include, for example: sensing infrared LED light reflected by the peripheral object; and disabling the second microphone that is operating.

The operation of the method may further include confirming that only the first microphone is operating.

Blocking the echo generation by eliminating a sound that is output from a speaker and input to the first microphone may include, for example: detecting that the sound output from the speaker is input to the first microphone; and eliminating the sound before the sound input to the first microphone is output through the speaker.

The echo may be, for example, a sound that is generated when the sound output from the speaker and input to the first microphone is again output through the speaker.

According to another aspect of the present invention, an electronic device having a first microphone and a second microphone may include, for example: a sensor located within a predetermined range from the second microphone to sense a peripheral object; and a processor unit for controlling the blocking of an operation of the second microphone when the sensor has sensed a peripheral object, and blocking echo generation by eliminating a sound that is output from a speaker and input to the first microphone.

The processor unit may confirm that the electronic device is operating in any one of a first mode and a second mode. The first mode may be, for example, a loudspeaker mode, and the second mode may be, for example a Video Telephony (VT) mode. The sensor may be, for example, an optical proximity sensor.

In a non-limiting aspect, the sensor may emit infrared LED light and sense infrared LED light reflected by the peripheral object.

The sensor may sense light, for example, infrared LED light reflected by the peripheral object, and the processor unit may disable the second microphone that is operating.

The processor unit may confirm that only the first microphone is operating.

The first microphone may receive an input of the sound output from the speaker, and the processor unit may eliminate the sound before the sound input to the first microphone is output through the speaker.

The echo may be a sound that is generated when the sound output from the speaker and input to the first microphone is again output through the speaker.

### BRIEF DESCRIPTION OF THE DRAWINGS

The above and other objects, features and advantages of the present invention will become better appreciated by a person of ordinary skill in the art from the following detailed description when taken in conjunction with the accompanying drawings in which:

FIG. 1 is a diagram illustrating an overall exemplary configuration of an electronic device blocking echo generation by eliminating a sound output from a speaker according to the present invention;

FIG. 2 is a diagram illustrating the blocking an echo in an electronic device operating in a loudspeaker mode according to an embodiment of the present invention;

FIG. 3 is a diagram illustrating the blocking an echo in an electronic device operating in a VT mode according to an embodiment of the present invention;

FIG. 4 is a diagram illustrating the operation/non-operation of a first microphone of an electronic device operating in a VT mode according to an embodiment of the present invention;

FIG. 5 is a diagram illustrating the operation of a sensor located in the periphery of a second microphone of an electronic device according to an embodiment of the present invention;

FIG. 6 is a diagram illustrating the blocking an echo in an electronic device operating in a loudspeaker mode according an embodiment of to the present invention;

FIG. 7 is a diagram illustrating the blocking an echo in an electronic device operating in a VT mode according to an embodiment of the present invention;

FIG. 8 is a flow diagram illustrating operation of a method for an electronic device operating in a loudspeaker mode according to an embodiment of the present invention;

FIG. 9 is a flow diagram illustrating operation of a method for an electronic device operating in a VT mode according to an embodiment of the present invention; and

FIG. 10 is a block diagram illustrating a configuration of an electronic device according to an embodiment of the present invention.

### DETAILED DESCRIPTION

Exemplary embodiments of the present invention will be described herein below with reference to the accompanying drawings. In the following description, detailed descriptions of well-known functions or configurations may be omitted when their inclusion could unnecessarily obscure appreciation by an artisan of the subject matter of the present invention. Also, the terms used herein are defined according to the functions of the present invention. Thus, the terms may vary depending on users' or operators' intentions or practices. Therefore, the terms used herein should be understood based on the descriptions made herein as would be understood by the person of ordinary skill in the art.

Throughout the specification the terms “front side” and “rear side” are used. An artisan should understand and appreciate that each term is describing what an artisan would understand to be as the front, and the rear of the device. For example, the front side of electronic device would be the side that typically has a display and faces the user, and in the case of a handheld electronic device, the rear side is the back of the electronic device that is typically held by a user or placed on a table, floor, etc. While it is possible that the rear could also have a display, these terms should be understood as conventions that could be reversed. More specifically, there are various ways of arranging the microphone and sensors can used to achieve the effect according to the present invention, and the invention is not limited to arrangements shown and described herein, nor to the front, rear, top, bottom terminology used herein.

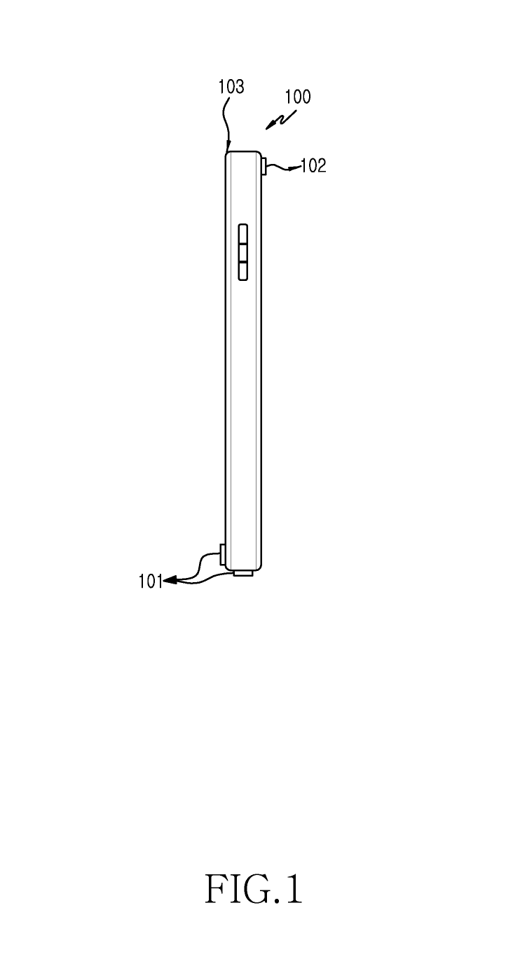

FIG. 1 is a diagram illustrating an overall configuration of an electronic device blocking echo generation by eliminating a sound output from a speaker according to the present invention. As illustrated in FIG. 1, there is an assumption that an electronic device 100 according to the present invention includes two microphones 101 and 102. Specifically, the first microphone 101 may be provided at the front bottom or the base side of the electronic device, and the second microphone 102 may be provided at the rear top or bottom of the electronic device.

In particular, the second microphone 102 may be located in other positions than at the rear top or bottom of the electronic device, for example, at any position in or on the rear side of the electronic device. In this embodiment, the second microphone 102 is assumed to be located at the rear top of the electronic device, as shown in FIG. 1.

The electronic device 100 having dual microphones uses the volume difference between the first microphone 101 and the second microphone 102 of respective frequency bands to block an echo generated in the electronic device and suppress a noise generated in the periphery. Herein, the echo may be defined as a sound that is generated when a sound generated by a speaker 103 of the electronic device is input to the microphone and the same sound is again output through the speaker 103 with a time difference. For example, any user of an electronic device has experienced, at least once, an echo that is generated when a sound generated by a speaker is again output through the speaker. However, as described above, the electronic device having dual microphones uses the volume difference between the first microphone 101 and the second microphone 102 of respective frequency bands to block an echo that may be generated in the electronic device. One non-limiting way the volume difference can be compared by, for example, a comparator or a processing unit that can compare a difference in the sound received, or the sound signal generated, by the first microphone versus the second microphone.

Also, the noise generated in the periphery of the electronic device may be defined as a noise that is output through a speaker of an electronic device of the other party when a peripheral noise generated in the periphery of the electronic device during a call is input to the microphone. For example, when the user of the electronic device is located at a construction site with severe peripheral noises and the user calls another party, the other party receives not only the voice of the user but also receives the noises generated from the construction site.

However, as described above, in the case where the electronic device having a dual microphone uses the volume difference between the first microphone 101 and the second microphone 102 of respective frequency bands to block a noise that may be generated in the periphery.

In a conventional electronic device having dual microphones, because a second microphone does not operate in a specific mode, an echo that may be generated in the electronic device cannot be effectively blocked, and a noise generated in the periphery of the electronic device is output through a speaker of the other party intactly. More particularly, in the conventional electronic device, when the second microphone located at the rear side cannot normally operate in a loudspeaker mode and a VT (Video Telephony) mode, an echo and a noise cannot be blocked. One reason is that in the loudspeaker mode, because the electronic device is often used with the rear side placed on a floor, the sound output from a speaker is input through the floor because the second microphone is blocked by the floor, increasing the difficulty to achieve the original purpose of blocking an echo or blocking a noise generated in the periphery. Also, in the VT mode, when a user holds the second microphone located at the rear side of the electronic device, the sound output from the speaker is input through a hand of the user because the second microphone is blocked by the hand of the user, there is difficulty in blocking an echo or block a noise generated in the periphery.

In contrast to the aforementioned issues of a conventional device, the electronic device of the present invention includes a sensor in the periphery of the second microphone, and thus can block an echo more effectively by blocking the operation of the second microphone when the sensor has sensed a peripheral object. Hereinafter, a method for operating the electronic device to block an echo in a loudspeaker mode and a VT mode will be described in more detail.

First, there is an assumption that the electronic device has confirmed that operation is currently in a loudspeaker mode, and that the second microphone 102 is provided at the rear top of the electronic device, and the electronic device is placed on a floor. Based on the above assumption, the electronic device determines whether a sensor located within a predetermined range from the second microphone 102 has sensed a peripheral object. More specifically, the electronic device determines whether an optical proximity sensor located within a predetermined range from the second microphone 102 has sensed a peripheral object.

Herein, determining whether the optical proximity sensor has sensed the peripheral object includes: emitting infrared Light Emitting Diode (LED) light by a light emitting unit of the optical proximity sensor; and determining whether a light receiving unit of the optical proximity sensor has sensed infrared LED light reflected by the peripheral object. On the above assumption, when the light emitting unit of the optical proximity sensor emits infrared LED light, the emitted infrared LED light is reflected by the floor on which the electronic device was disposed, and the light receiving unit of the optical proximity sensor senses the infrared LED light reflected by the floor. Thereafter, the electronic device blocks echo generation by eliminating a sound that is output from the speaker 103 and input to the first microphone 101 that generates an echo. Specifically, the electronic device senses the infrared LED light reflected by the peripheral object, and disables the second microphone 102 that is operating.

More particularly, an echo canceller provided in the electronic device blocks echo generation in the speaker by blocking a sound that is output from the speaker and input to the first microphone 101 when the electronic device senses the light reflected by the peripheral object. In conclusion, although the electronic device according to the present invention operates both the first microphone 101 and the second microphone 102, the electronic device can provide for the best condition under the circumstances by operating only the first microphone 101 to prevent generation of an echo by blocking the operation of the second microphone 102 according to conditions by using the optical proximity sensor located within the predetermined range from the second microphone 102. That is, in the conventional electronic device operating in a loudspeaker mode, although the second microphone is blocked by a floor, since a speaker sound of the electronic device is input through the floor by the operation of the second microphone, it is difficult to achieve the original purpose of blocking an echo. However, the electronic device according to the present invention includes an optical proximity sensor in the periphery of the second microphone 102, and can block an echo effectively by blocking the operation of the second microphone 102 when determining that the second microphone 102 is blocked by the floor.

Next, a process for blocking an echo in the electronic device operating in a VT mode will be described in detail. First, there is an assumption that the electronic device is operating in a VT mode, the second microphone 102 is provided at the rear top of the electronic device, and the second microphone 102 is blocked by a hand of the user according to a holding method of the user. Based on the above assumption, the electronic device determines whether a sensor located within a predetermined range from the second microphone 102 has sensed a peripheral object. More specifically, the electronic device determines whether an optical proximity sensor located within a predetermined range from the second microphone 102 has sensed a peripheral object. Herein, the determining whether the optical proximity sensor has sensed the peripheral object includes: emitting infrared LED light by a light emitting unit of the optical proximity sensor; and determining whether a light receiving unit of the optical proximity sensor has sensed infrared LED light reflected by the peripheral object. On the above assumption, when the light emitting unit of the optical proximity sensor emits infrared LED light, the emitted infrared LED light is reflected by the hand of the user, and the light receiving unit of the optical proximity sensor senses the infrared LED light reflected by the hand of the user.

Thereafter, the electronic device blocks echo generation by eliminating a sound that is output from the speaker 103 and input to the first microphone 101. Specifically, the electronic device senses the infrared LED light reflected by the peripheral object, and disables the second microphone 102 that is operating. In other words, an echo canceller provided in the electronic device blocks echo generation by blocking a sound that is output from the speaker 103 and input to the first microphone 101. In conclusion, although the electronic device according to the present invention operates both the first microphone 101 and the second microphone 102, the electronic device can provide for the (second) best condition under the circumstances by operating only the first microphone 101 by blocking the operation of the second microphone 102 when conditions are as discussed herein above by using the optical proximity sensor located within the predetermined range from the second microphone 102.

Moreover, in the conventional electronic device operating in a VT mode, although the second microphone is blocked by a hand of the user, because the hand does not always completely seal off the microphone, and the hand does not operate as a complete soundproofing devices, and as such a speaker sound of the electronic device is input through the hand of the user by the operation of the second microphone. Thus, in the conventional device there is still a great deal of difficulty in achieving the original purpose of blocking an echo.

In contrast, in the electronic device and method according to the present invention includes an optical proximity sensor located in the periphery of the second microphone 102, and can block an echo effectively by blocking the operation of the second microphone 102 when determining that the second microphone 102 is blocked by the hand of the user according to the holding method of the user.

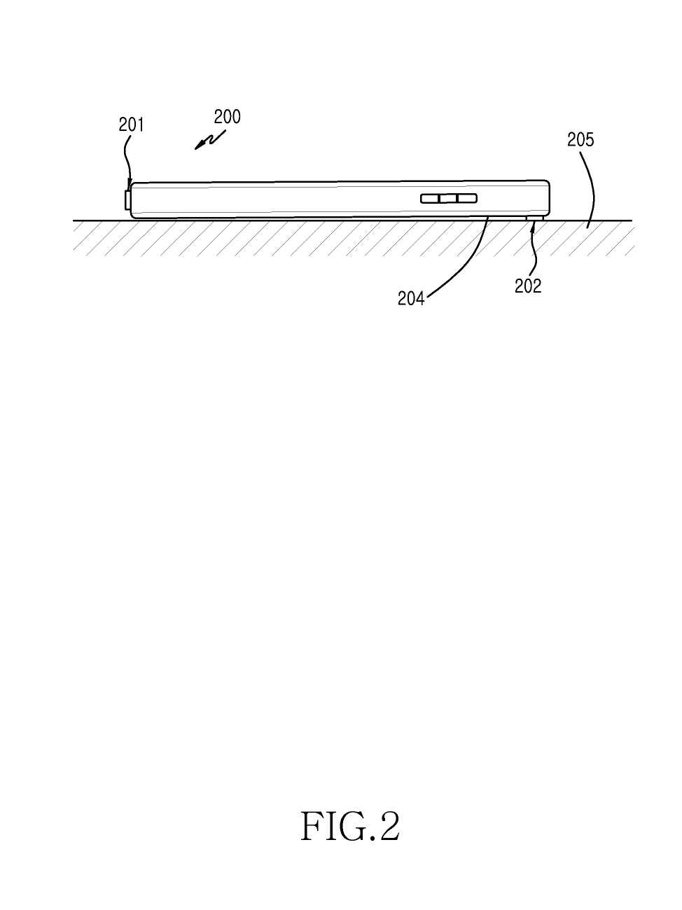

FIG. 2 is a diagram illustrating an embodiment of blocking an echo in an electronic device operating in a loudspeaker mode according to the present invention. As illustrated in FIG. 2, it is assumed that an electronic device 200 according to the present invention includes two microphones 201 and 202. Specifically, the first microphone 201 is provided at the base side of the electronic device, and the second microphone 202 is provided at the rear top of the electronic device. However, the first microphone 201 may be provided at the front bottom of the electronic device 200, and the second microphone 202 may be provided at any position (e.g., bottom or middle) on the rear side of the electronic device. In this embodiment, it is assumed that the second microphone 202 is located on the rear side at the top of the electronic device 200.

The electronic device 200 having dual microphones 201, 202 uses the volume difference between the first microphone 201 and the second microphone 202 of respective frequency bands to block an echo generated in the electronic device. Herein, the echo may be defined as a sound that is generated when an output of sound generated by a speaker of the electronic device is input to the microphone and the same sound is again output through the speaker with a time difference. For example, most users of electronic devices have experienced, at least once, an echo that is generated when a sound generated by a speaker is again output through the speaker. However, as described above, the electronic device having dual microphones uses the volume difference between the first microphone 201 and the second microphone 202 of respective frequency bands to block an echo that may be generated in the electronic device. One non-limiting way the volume difference can be compared by, for example, a comparator or a processing unit that can compare a difference in the sound received, or the sound signal generated, by the first microphone versus the second microphone.

The electronic device senses the infrared LED light reflected by the peripheral object, and disables the second microphone 102 that is operating. In other words, an echo canceller provided in the electronic device blocks echo generation by blocking a sound that is output from the speaker 103 and input to the first microphone 101.

However, when a conventional electronic device having dual microphones operates in a loudspeaker mode, there is difficulty in effectively blocking an echo that may be generated in the electronic device. Specifically, in the loudspeaker mode, since the second microphone located at the rear side cannot operate normally, an echo cannot be blocked. In other words, in the loudspeaker mode, because the electronic device is often used with the rear side placed on a floor, since a sound output from a speaker is input through the floor 205 because the second microphone is blocked by the floor 205, there is difficulty to achieve the original purpose of blocking an echo. However, the electronic device of the present invention includes a sensor 204 in the periphery of the second microphone 202, and can block an echo more effectively by blocking the operation of the second microphone 202 when the sensor 204 has sensed the presence of a peripheral object. Hereinafter, a method for operating the electronic device to block an echo in a loudspeaker mode will be described more in detail.

First, there is assumption that: the electronic device has confirmed that the mode of operation is currently in a loudspeaker mode, the second microphone 202 is provided at top along the rear side of the electronic device, and the electronic device is placed on a floor 205.

On the above assumption, the electronic device 200 determines whether a sensor located within a predetermined range from the second microphone 202 has sensed a peripheral object (in this particular case, floor 205). Specifically, the electronic device determines whether an optical proximity sensor 204 located within a predetermined range from the second microphone 202 has sensed a peripheral object. Herein, determining whether the optical proximity sensor 204 has sensed the peripheral object includes: emitting infrared LED light by a light emitting unit of the optical proximity sensor; and determining whether a light receiving unit of the optical proximity sensor 204 has sensed infrared LED light reflected by the peripheral object. On the above assumption, when the light emitting unit of the optical proximity sensor emits infrared LED light, the emitted infrared LED light is reflected by the floor 205, and the light receiving unit of the optical proximity sensor 204 senses the infrared LED light reflected by the floor 205. Thereafter, the electronic device 200 blocks echo generation by eliminating a sound that is output from the speaker and input to the first microphone 201. Specifically, the electronic device 200 senses the infrared LED light reflected by the peripheral object (in this case, the peripheral object being the floor 205), and disables the second microphone 202 that is operating. In other words, an echo canceller provided in the electronic device blocks echo generation in the speaker by blocking a sound that is output from the speaker and input to the first microphone 201. In conclusion, although the electronic device according to the present invention operates both the first microphone 201 and the second microphone 202, the electronic device can provide for the second best condition by operating only the first microphone 201 and by blocking the operation of the second microphone 202 according to conditions by using the optical proximity sensor 204 located within the predetermined range from the second microphone 202.

Whereas in the conventional electronic device operating in a loudspeaker mode, although the second microphone is blocked by a floor, since a speaker sound of the electronic device is input through the floor by the operation of the second microphone, there is difficulty to achieve the original purpose of blocking an echo. However, as shown at least in FIG. 2 of the electronic device 200 according to the present invention, the inclusion of an optical proximity sensor 204 in proximity to (the periphery of) the second microphone 202, and can block an echo effectively by blocking the operation of the second microphone 202 when the electronic device determines that the second microphone 202 is blocked by the floor 205 when receiving a signal from the proximity sensor 204.

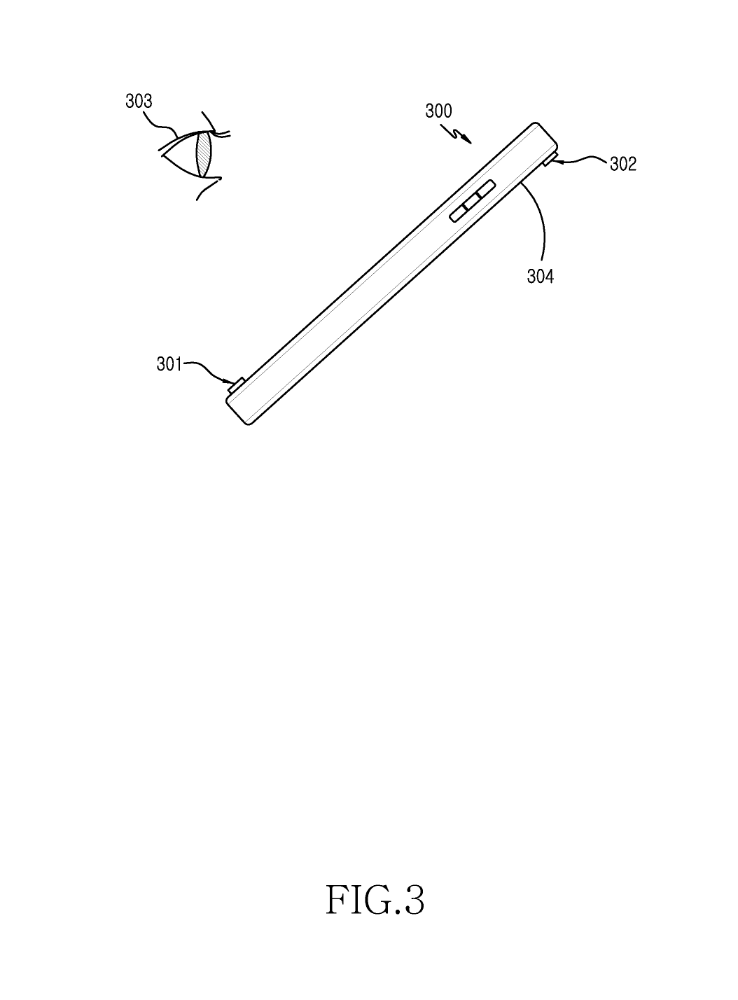

FIG. 3 is a diagram illustrating an embodiment of blocking an echo in an electronic device operating in a VT mode according to the present invention. As illustrated in FIG. 3, it is assumed that an electronic device 300 according to the present invention includes two microphones 301 and 302. Specifically, the first microphone 301 is provided at the bottom of the front side of the electronic device 300, and the second microphone 302 is provided at the top of the rear side of the electronic device. However, the first microphone 301 may be provided at the base side of the electronic device, and the second microphone 302 may be provided at any position (e.g., bottom or middle) on the rear side of the electronic device 300. In this embodiment, there is an assumption that the first microphone 301 is provided at the front bottom of the electronic device, and the second microphone 302 is provided at the rear top of the electronic device.

The electronic device having dual microphones uses the volume difference between the first microphone 301 and the second microphone 302 of respective frequency bands to block an echo generated in the electronic device. Herein, the echo may be defined as a sound that is generated when a sound generated by a speaker of the electronic device is input to the microphone and the same sound is again output through the speaker with a time difference. For example, any user of an electronic device has experienced, at least once, an echo that is generated when a sound generated by a speaker is again output through the speaker. However, as described above, the electronic device having dual microphones uses the volume difference between the first microphone 301 and the second microphone 302 of respective frequency bands to block an echo that may be generated in the electronic device.

A process for blocking an echo in the electronic device operating in a VT mode will now be described in detail. First, there is an assumption that: the electronic device 300 is operating in a VT mode, the second microphone 302 is provided at the top of the rear side of the electronic device, and the second microphone 302 is blocked by a hand of the user according to a holding method of the user while holding device 300. Herein, the VT mode may be defined as a mode in which the user calls another party while viewing the screen of the electronic device 300. In other words, in the VT mode, the user may often call another party while holding the electronic device 300 in one hand and viewing the screen of the electronic device via eyes 303 of the user.

Based on the above assumption, the electronic device 300 determines whether a sensor 304 located within a predetermined range from the second microphone 302 has sensed a peripheral object. Specifically, the electronic device determines whether an optical proximity sensor 304 located within a predetermined range from the second microphone 302 has sensed a peripheral object. Herein, determining whether the optical proximity sensor 304 has sensed the peripheral object includes: emitting infrared LED light by a light emitting unit of the optical proximity sensor 304; and determining whether a light receiving unit of the optical proximity sensor 304 has sensed infrared LED light reflected by the peripheral object (in this case a user's hand). Based on the above assumption, when the light emitting unit of the optical proximity sensor 304 emits infrared LED light, the emitted infrared LED light is reflected by the hand of the user, and the light receiving unit of the optical proximity sensor 304 senses the infrared LED light reflected by the hand of the user. Thereafter, the electronic device 300 blocks echo generation by eliminating a sound that is output from the speaker and input to the first microphone 301. Specifically, the electronic device 300 senses the infrared LED light reflected by the hand of the user, and disables the second microphone 302 that is operating. In other words, an echo canceller provided in the electronic device 300 blocks echo generation in the speaker by blocking a sound that is output from the speaker and input to the first microphone 301. In conclusion, although the electronic device according to the present invention operates both the first microphone 301 and the second microphone 302, the electronic device can provide for the second best condition by operating only the first microphone 301 by blocking the operation of the second microphone 302 according to conditions by using the optical proximity sensor located within the predetermined range from the second microphone 302. That is why in the conventional electronic device operating in a VT mode, although the second microphone is blocked by a hand of the user, since a speaker sound of the electronic device is input through the hand of the user by the operation of the second microphone, there is difficulty to achieve the original purpose of blocking an echo.

However, in the electronic device 300 according to the present invention includes an optical proximity sensor 304 in the periphery of the second microphone 302, and can block an echo effectively by blocking the operation of the second microphone 302 when determining that the second microphone 302 is blocked by the hand of the user according to the holding method of the user.

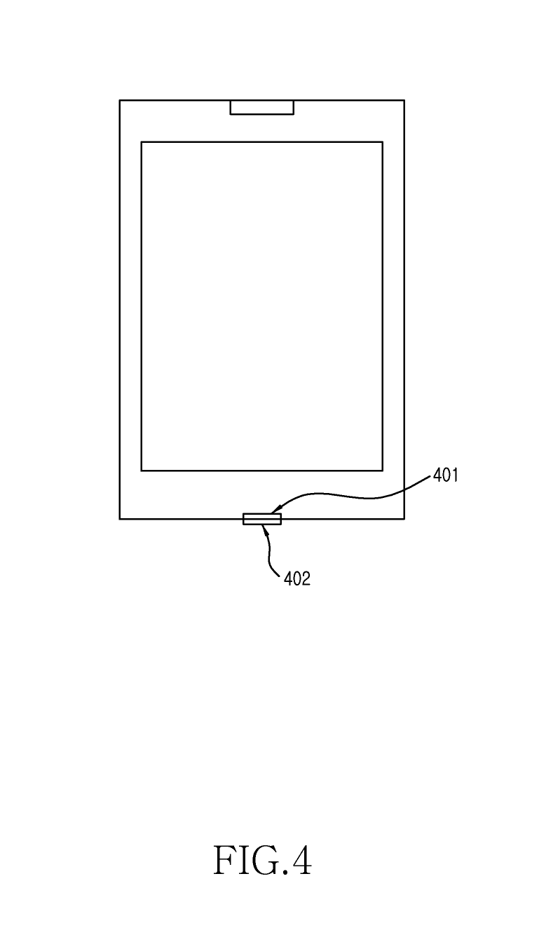

FIG. 4 is a diagram illustrating an embodiment of the operation/non-operation of a first microphone (401,402) of an electronic device 400 operating in a VT mode according to the present invention. As illustrated in FIG. 4, a first microphone of an electronic device according to the present invention may be located at the front bottom (401) or the base side (402) of the electronic device. Hereinafter, on the assumption that the electronic device is operating in a VT mode, a second microphone (not shown in FIG. 4) is provided at any region on the rear side of the electronic device, and the user holds the second microphone in a hand of the user (although not illustrated in FIG. 4), the operation of the first microphone of the electronic device will be described in more detail.

Based on the assumption in the previous paragraph, there can be confirmation that the electronic device is operating in the VT mode with the second microphone covered by the hand of the user. Thereafter, the electronic device blocks the operation of the second microphone when an optical proximity sensor located within a predetermined region in the periphery of the second microphone confirms that the second microphone is covered by the hand of the user. In other words, the electronic device operates with only the first microphone. On the above assumption, both the first microphone and the second microphone located at the rear side operate in the conventional electronic device. Therefore, when the second microphone located at the rear side is covered by the hand of the user, there is difficulty to effectively block generation of an echo. More specifically, because a sound output from the speaker of the electronic device is input through the hand of the user, an echo cannot be blocked. In other words, in the conventional electronic device operating in the VT mode, since the second microphone always operates in a conventional electronic device regardless of whether the second microphone is covered by the hand of the user, an echo cannot be blocked.

However, in the present invention, by operating only the first microphone by blocking the second microphone in the case as the above example, the electronic device according to the present invention can block generation of an echo far more effectively as compared to the conventional case, by blocking operation of the one of the microphones to prevent generation of an echo as opposed to operating both of the dual microphones.

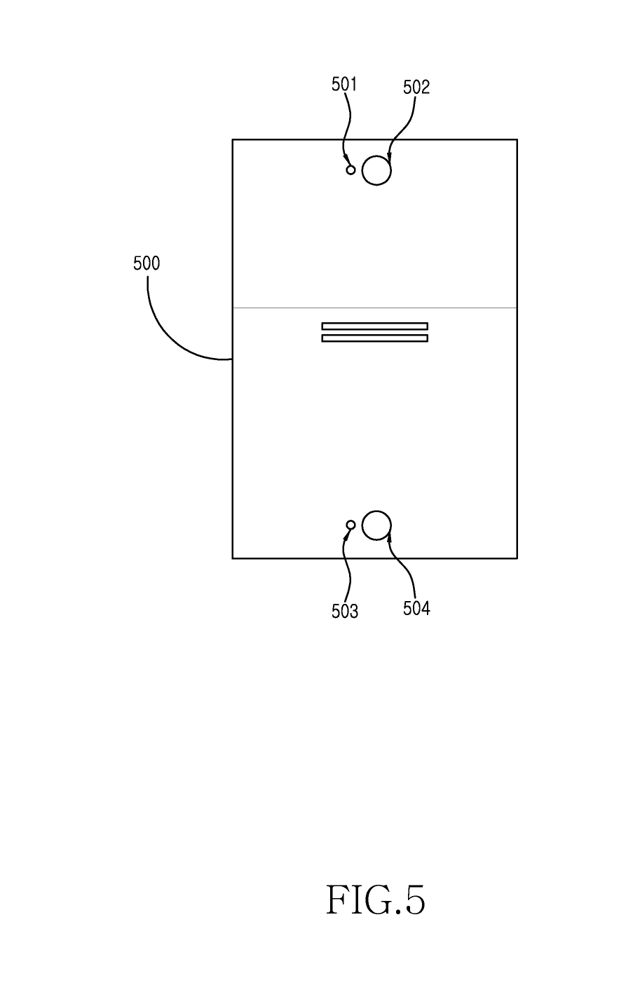

FIG. 5 is a diagram illustrating an embodiment of the operation of a sensor 502 located in the periphery of a second microphone 501 of an electronic device according to the present invention. As illustrated in FIG. 5, in an electronic device according to the present invention, a second microphone may be provided at any region on the rear side of the electronic device, and an optical proximity sensor may be provided in the periphery of the second microphone.

FIG. 5 illustrates an embodiment showing the second microphone being at two possible places, although an artisan will appreciate and understand that the two locations are provided for illustrative purposes only. For example FIG. 5 shows the case where a second microphone 501 and an optical proximity sensor 502 are located at the top of the rear side of the electronic device, and the case where a second microphone 503 and an optical proximity sensor 504 are located at the bottom of the rear side of the electronic device.

First, based on the assumption in the cast that the second microphone 501 and the optical proximity sensor 502 are located at the top of the rear side of the electronic device, a sensor operation method will be described in detail. The optical proximity sensor 502 of the electronic device is located within a predetermined region in the periphery of the second microphone 501, and determines whether the second microphone 501 is covered by a peripheral object when in a loudspeaker mode and/or a VT mode. More specifically, a light emitting unit of the optical proximity sensor 502 may emit infrared LED light, and a light receiving unit of the optical proximity sensor 502 may sense infrared LED light reflected by a peripheral object. In other words, the optical proximity sensor 502 emits infrared LED light and senses infrared LED light reflected by a peripheral object, to determine whether the second microphone 501 is covered by the peripheral object. When the optical proximity sensor 502 has sensed the reflected infrared LED light, the electronic device 500 disables the second microphone that is operating. Therefore, the electronic device according to the present invention can block an echo effectively by blocking the operation of the second microphone 501 when determining in the case that the second microphone 501 is covered by the peripheral object, without always operating the second microphone 501.

A sensor operation method is also the same in the case where the second microphone 503 and the optical proximity sensor 504 are located at the bottom of the rear side of the electronic device 500. In other words, the optical proximity sensor 504 of the electronic device is located within a predetermined region in the periphery of the second microphone 503, and determines whether the second microphone 503 is covered by a peripheral object in a loudspeaker mode and a VT mode. Specifically, a light emitting unit of the optical proximity sensor 504 may emit infrared LED light, and a light receiving unit of the optical proximity sensor 504 may sense infrared LED light reflected by a peripheral object. That is, the optical proximity sensor 504 emits infrared LED light and senses infrared LED light reflected by a peripheral object, to determine whether the second microphone 503 is covered by the peripheral object. When the optical proximity sensor 504 has sensed the reflected infrared LED light, the electronic device 500 disables the second microphone 503 that is operating in the case where the second microphone is arranged at the bottom of the rear side of the electronic device 500. Therefore, the electronic device 500 according to the present invention can block an echo effectively by blocking the operation of the second microphone 503 when determining that the second microphone 503 is covered by the peripheral object, without always operating the second microphone 503.

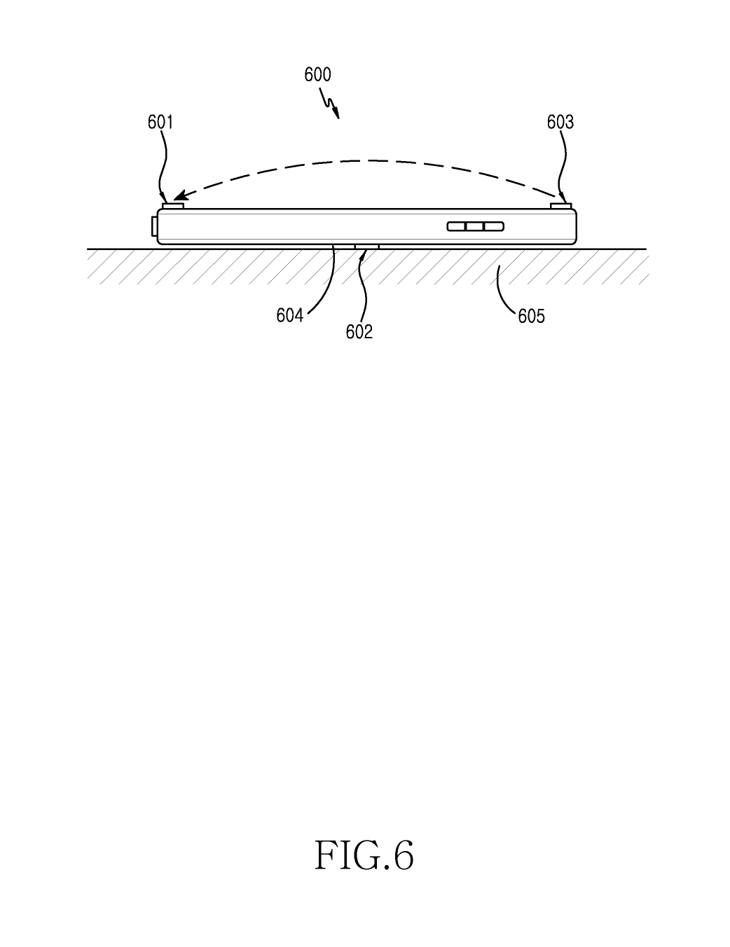

FIG. 6 is a diagram illustrating another embodiment of blocking an echo in an electronic device operating in a loudspeaker mode according to the present invention. As illustrated in FIG. 6, it is assumed that an electronic device 600 according to the present invention includes two microphones 601 and 602, the electronic device 600 is operating in a loudspeaker mode, and the electronic device is placed on a floor 605. Specifically, the first microphone 601 is provided at the bottom of the front side of the electronic device, and the second microphone 602 is provided at the center of the rear side of the electronic device.

As previously discussed, when a conventional electronic device having dual microphones operates in a loudspeaker mode, there is difficulty to effectively block an echo that may be generated in the electronic device. In the loudspeaker mode, in a conventional device the second microphone located at the rear center cannot operate normally, an echo cannot be blocked. Specifically, in the loudspeaker mode, because the electronic device is often used with the rear side placed on a floor, since a sound output from a speaker is input through the floor because the second microphone is blocked by the floor, it is difficult to achieve the original purpose of blocking an echo. However, the electronic device of the present invention includes a sensor 604 in the periphery of the second microphone 602, and can block an echo more effectively by blocking the operation of the second microphone 602 when the sensor has sensed a peripheral object. Hereinafter, a method for operating the electronic device to block an echo in a loudspeaker mode will be described in detail.

First, there is an assumption that the electronic device has confirmed that it is operating in a loudspeaker mode, the second microphone 602 is provided at the rear center of the electronic device, and the electronic device is placed on a floor 605. Based on the above assumption, the electronic device determines whether a sensor 604 located within a predetermined range from the second microphone 602 has sensed a peripheral object. Specifically, the electronic device determines whether, for example, an optical proximity sensor 604 located within a predetermined range from the second microphone 602 has sensed a peripheral object. Herein, determining whether the optical proximity sensor has sensed the peripheral object includes: emitting infrared LED light by a light emitting unit of the optical proximity sensor 604; and determining whether a light receiving unit of the optical proximity sensor 604 has sensed infrared LED light reflected by the peripheral object. On the above assumption, when the light emitting unit of the optical proximity sensor 604 emits infrared LED light, the emitted infrared LED light is reflected by the floor, and the light receiving unit of the optical proximity sensor 604 senses the infrared LED light reflected by the floor 605 (i.e. the peripheral object). Thereafter, the electronic device blocks echo generation by eliminating a sound that is output from the speaker 603 and input to the first microphone 601. Specifically, the electronic device 600 senses the infrared LED light reflected by the peripheral object (floor, hand, table, etc.), and disables the second microphone 602 that is operating. In other words, an echo canceller provided in the electronic device blocks echo generation in the speaker 603 by blocking a sound that is output from the speaker and input to the first microphone 601. In conclusion, although the electronic device according to the present invention operates both the first microphone 601 and the second microphone 602, the electronic device can provide for the second best condition by operating only the first microphone 601 by blocking the operation of the second microphone 602 according to detected conditions by using the optical proximity sensor located within the predetermined range from the second microphone 602. In other words, whereas in the conventional electronic device operating in a loudspeaker mode, although the second microphone is blocked by a floor, since a speaker sound of the electronic device is input through the floor by the operation of the second microphone, it is difficult to achieve the original purpose of blocking an echo. However, in the electronic device 600 according to the present invention includes an optical proximity sensor 604 in the periphery of the second microphone 602, and can block an echo effectively by blocking the operation of the second microphone 602 when determining that the second microphone 602 is blocked by the floor.

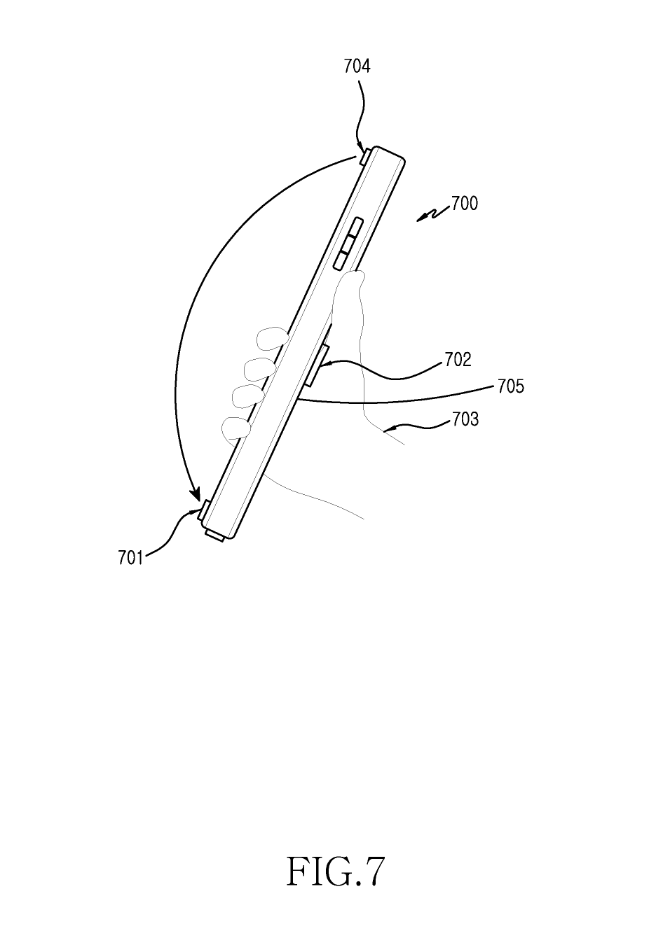

FIG. 7 is a diagram illustrating another embodiment of blocking generation of an echo in an electronic device operating in a VT mode according to the present invention. As illustrated in FIG. 7, it is assumed that an electronic device according to the present invention includes two microphones 701 and 702, the second microphone 702 is blocked by a hand 703 of the user, and the electronic device is operating in a VT mode. Specifically, the first microphone 701 is provided at the bottom of the front side of the electronic device, and the second microphone 702 is provided at the center of the rear side of the electronic device. A process for blocking an echo in the electronic device operating in a VT mode will be described in detail. First, it is assumed that the electronic device is operating in a VT mode, the second microphone 702 is provided at the rear center of the electronic device, and the second microphone 702 is blocked by the hand 703 of the user according to a holding method of the user. In the VT mode, the user would typically call or receive a call from the other party while holding the electronic device in hand 703. On the above assumption, the electronic device 700 determines whether a sensor 705 located within a predetermined range from the second microphone 702 has sensed a peripheral object. Specifically, the electronic device 700 determines whether an optical proximity sensor 705 located within a predetermined range from the second microphone 702 has sensed a peripheral object. Herein, determining whether the optical proximity sensor has sensed the peripheral object includes: emitting infrared LED light by a light emitting unit of the optical proximity sensor 705; and determining whether a light receiving unit of the optical proximity sensor 705 has sensed infrared LED light reflected by the peripheral object. On the above assumption, when the light emitting unit of the optical proximity sensor 705 emits infrared LED light, the emitted infrared LED light is reflected by the hand 703 of the user, and the light receiving unit of the optical proximity sensor senses the infrared LED light reflected by the hand 703 of the user. Thereafter, the electronic device blocks echo generation by eliminating a sound that is output from a speaker 704 which would be input to the first microphone 701. Specifically, the electronic device senses the infrared LED light reflected by the hand 703 of the user, and disables the second microphone 702 that is operating. In other words, an echo canceller provided in the electronic device blocks echo generation in the speaker by blocking a sound that is output from the speaker 704 and input to the first microphone 701. In conclusion, although the electronic device according to the present invention operates both the first microphone 701 and the second microphone 702, the electronic device 700 can provide for the best condition under the circumstances by operating only the first microphone 701 and block the operation of the second microphone 702 according to conditions by using the optical proximity sensor located within the predetermined range from the second microphone 702.

The electronic device according to the present invention includes an optical proximity sensor 705 in the periphery of the second microphone 702, and can block an echo effectively by blocking the operation of the second microphone 702 when determining that the second microphone 702 is blocked by the hand of the user according to the holding method of the user.

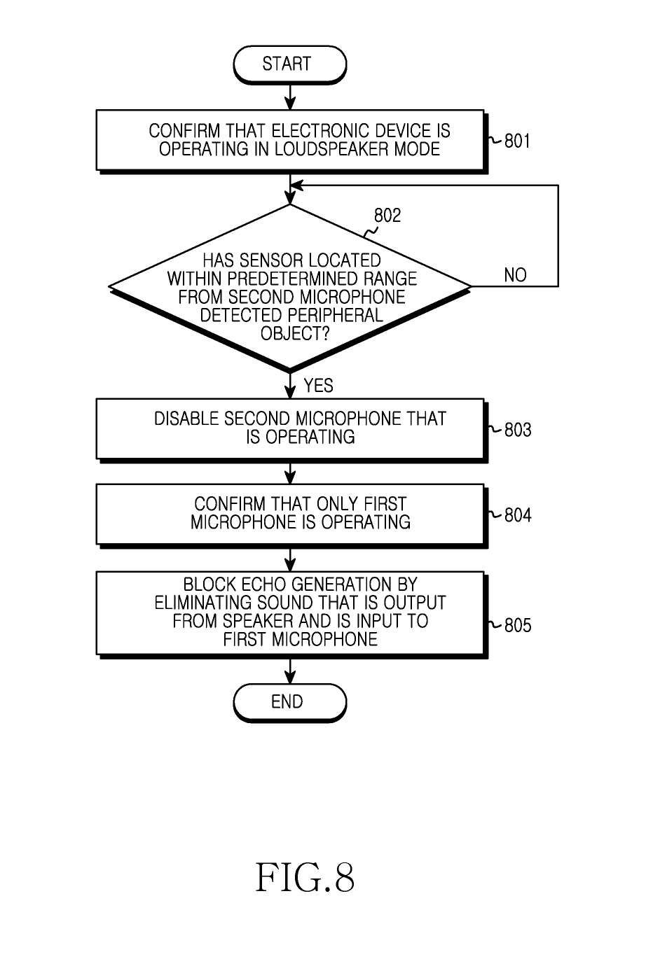

FIG. 8 is a flow diagram illustrating operation of a method for an electronic device operating in a loudspeaker mode according to an embodiment of the present invention. Herein, Loudspeaker is one of the speaker.

First, as illustrated in FIG. 8, at (801) an electronic device according to the present invention confirms that the electronic device is operating in a loudspeaker mode. Herein, the loudspeaker mode may be defined as a mode in which a speaker is enabled and the user calls spaced apart from the electronic device, without performing transmission/reception in close proximity.

When confirming the operation in the loudspeaker mode, at (802) the electronic device determines whether a sensor is located within a predetermined range from the second microphone has sensed a peripheral object. Specifically, the electronic device determines whether an optical proximity sensor located within a predetermined range from the second microphone has sensed a peripheral object. Herein, determining whether the optical proximity sensor has sensed the peripheral object includes: emitting infrared LED light by a light emitting unit of the optical proximity sensor; and determining whether a light receiving unit of the optical proximity sensor has sensed infrared LED light reflected by the peripheral object. More particularly, when the light emitting unit of the optical proximity sensor emits infrared LED light, the emitted infrared LED light is reflected by the peripheral object, and the light receiving unit of the optical proximity sensor senses the infrared LED light reflected by the peripheral object, which can be a hand, table, floor, etc. just to name a few non-limiting possibilities.

After determining that the sensor located within the predetermined range from the second microphone has sensed the peripheral object, at (803) the electronic device disables the second microphone that is operating. Specifically, the electronic device senses the infrared LED light reflected off of the peripheral object, and disables the second microphone that is operating.

The electronic device of the present invention includes a sensor in the periphery of the second microphone, and blocks the operation of the second microphone when the sensor has sensed a peripheral object.

Thereafter, at (804) the electronic device confirms that only the first microphone is operating. Specifically, although the electronic device according to the present invention operates both the first microphone and the second microphone, the electronic device can provide for the best condition under the circumstance by operating only the first microphone in order to block the operation of the second microphone and prevent echo generation according to conditions, by using the optical proximity sensor located within the predetermined range from the second microphone.

When confirming the operation of only the first microphone, at (805) the electronic device blocks echo generation by eliminating a sound that is output from the speaker and input to the first microphone.

To reiterate, the electronic device according to the present invention includes an optical proximity sensor in the periphery of the second microphone, and can block an echo effectively by blocking the operation of the second microphone when determining that the second microphone is blocked by the peripheral object.

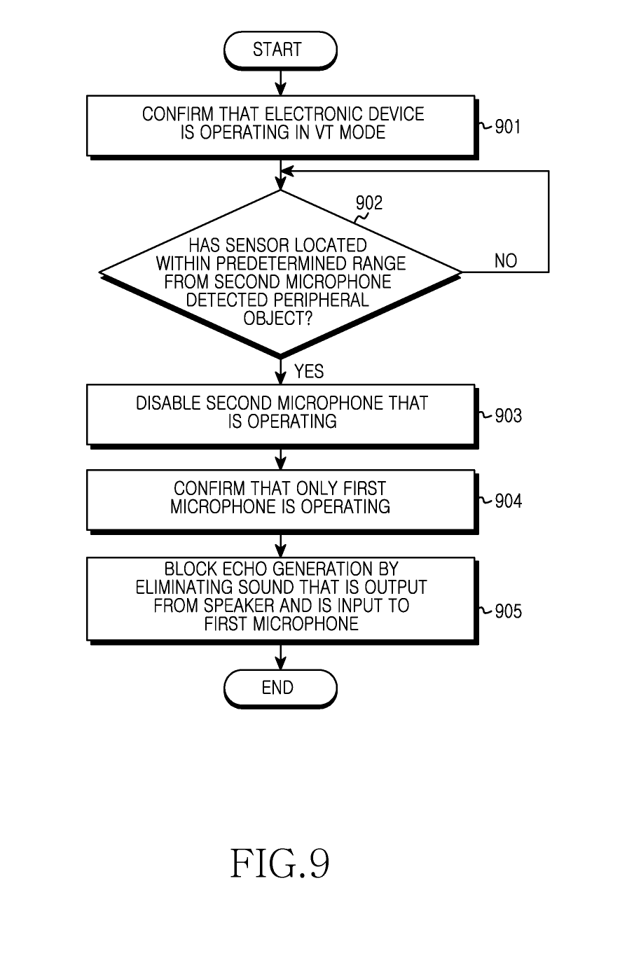

FIG. 9 is a flow diagram illustrating a method for operating an electronic device operating in a VT mode according to an embodiment of the present invention.

First, as illustrated in FIG. 9, at (901) an electronic device according to the present invention confirms that the electronic device is operating in a VT mode. Herein, the VT mode may be defined as a mode in which the user calls the other party or receives a call from the other party while viewing the screen of the electronic device. That is, in the VT mode, the user often calls the other party while holding the electronic device in one hand and viewing the screen of the electronic device.

When confirming the operation in the VT mode, at (902) the electronic device determines whether a sensor located within a predetermined range from the second microphone has sensed a peripheral object. Specifically, the electronic device determines whether an optical proximity sensor located within a predetermined range from the second microphone has sensed a peripheral object. Herein, determining whether the optical proximity sensor has sensed the peripheral object includes: emitting infrared LED light by a light emitting unit of the optical proximity sensor; and determining whether a light receiving unit of the optical proximity sensor has sensed infrared LED light reflected by the peripheral object. In other words, when the light emitting unit of the optical proximity sensor emits infrared LED light, the emitted infrared LED light is reflected by the peripheral object, and the light receiving unit of the optical proximity sensor senses the infrared LED light reflected by the floor.

When determining that the sensor located within the predetermined range from the second microphone has sensed the peripheral object, at (903) the electronic device disables the second microphone that is operating. Specifically, the electronic device senses the infrared LED light reflected by the peripheral object, and disables the second microphone that is operating.

The electronic device of the present invention includes a sensor in the periphery of the second microphone, and blocks the operation of the second microphone when the sensor has sensed the hand of the user (in this case the hand is the peripheral object).

Thereafter, at (904) the electronic device confirms that only the first microphone is operating. More specifically, although the electronic device according to the present invention operates both the first microphone and the second microphone, the electronic device can provide for the best condition under the circumstances by operating only the first microphone by blocking the operation of the second microphone according to conditions by using the optical proximity sensor located within the predetermined range from the second microphone.

When confirming the operation of only the first microphone, at (905) the electronic device blocks echo generation by eliminating a sound that is output from the speaker and input to the first microphone. For example, in the conventional electronic device operating in a loudspeaker mode, although the second microphone is blocked by a hand of the user, since a speaker sound of the electronic device is input through the hand of the user by the operation of the second microphone, it is difficult to achieve the original purpose of blocking an echo. However, the electronic device according to the present invention includes an optical proximity sensor in the periphery of the second microphone, and can block an echo effectively by blocking the operation of the second microphone when determining that the second microphone is blocked by the hand of the user.

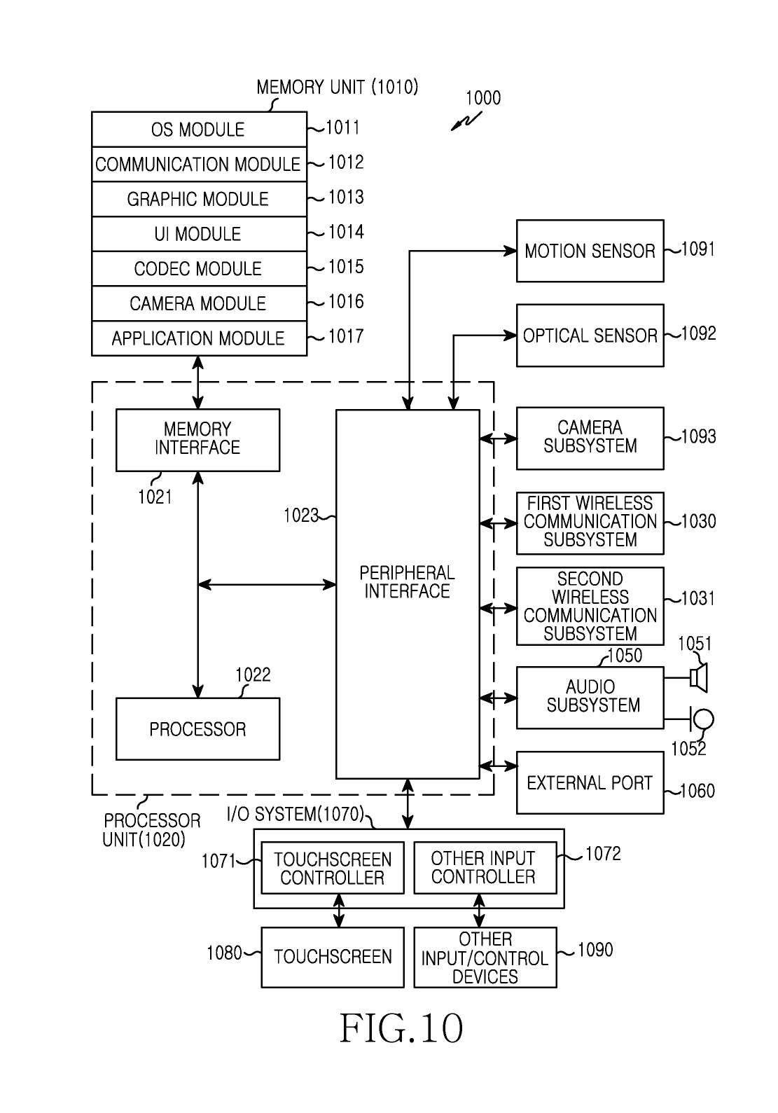

FIG. 10 is a block diagram illustrating a configuration of an electronic device according to an embodiment of the present invention. An electronic device 1000 according to an embodiment of the present invention may be a portable electronic device, examples of which may include portable terminals, mobile phones, mobile pads, media players, tablet computers, handheld computers, smart phones, mini-tablets, phablets, and personal digital assistants (PDAs). Also, the electronic device may be any portable electronic device including a combination of two or more functions of the above devices.

The electronic device 1000 includes a memory unit 1010, a processor unit 1020, a first wireless communication subsystem 1030, a second wireless communication subsystem 1031, an external port 1060, an audio subsystem 1050, a speaker 1051, a microphone 1052, an input/output (I/O) system 1070, a touchscreen 1080, and other input/control devices 1090. The memory unit 1010 and the external port 1060 may be provided in plurality.

The processor unit 1020 may include a memory interface 1021, at least one processor 1022, and a peripheral interface 1023. In some cases, the processor unit 1020 will also be referred to as a processor and in all cases includes circuitry such as, but not limited to an integrated circuit that is configured for operation. In the present invention, the processor unit 1020 controls blocking echo generation by eliminating a sound that is output from the speaker and input to the first microphone, by blocking (disabling) the operation of the second microphone when a peripheral object is detected. Also, the processor unit 1020 confirms that the electronic device is operating in any one of a first mode and/or a second mode, disables the second microphone that is operating, confirms that only the first microphone is operating, and eliminates a sound input to the first microphone before the sound is output through the speaker. Disabled should be interpreted broadly and can mean reducing power, powering off, or disabling control signals that would have been provided to the microphone.

The processor 1022 executes various programs comprising machine executable code to perform various functions for the electronic device 1000, and performs processes and controls for voice communication and data communication. In addition to these general functions, the processor 1022 executes a software module (instruction set of machine executable code) stored in the memory unit 1010 and performs various functions corresponding to the software module. That is, the processor 1022 is configured to perform the methods of the embodiments of the present invention in cooperation with software modules stored in the non-transitory memory unit 1010 that is loaded into the processor and executed. An artisan also appreciates that there can be more than one processor to distribute some of the tasks, and there can be microprocessors, sub-processors, all of which have circuitry for executing machine executable code and configuring the processor(s) for operation.

The processor 1022 may include circuitry such as at least one data processor, image processor, or codec. The data processor, the image processor, or the codec may be configured separately. Also, the processor may be configured by a plurality of processors performing different functions. The peripheral interface 1023 connects various peripheral devices and the I/O system 1070 of the electronic device 1000 to the processor 1022 and the memory unit 1010 (through the memory interface 1021).

The various elements of the electronic device 1000 may be coupled by at least one communication bus (not illustrated) or stream line (not illustrated).

The external port 1060 is used to connect a portable electronic device (not illustrated) to other electronic devices directly or indirectly through a network (e.g., Internet, intranet, or wireless LAN). The external port 1060 may be, for example, a universal serial bus (USB) port or a FireWire port, but is not limited thereto.

A motion sensor 1091 and an optical sensor 1092 may be connected to the peripheral interface 1023 to perform various functions. For example, the motion sensor 1091 and the optical sensor 1092 may be connected to the peripheral interface 1023 to sense a motion of the electronic device and detect light from an exterior of the device. In addition, other sensors such as a positioning system, a temperature sensor, and a biosensor may be connected to the peripheral interface 1023 to perform relevant functions. The sensor 1091 of the present invention is located within a predetermined range from the second microphone, senses a peripheral object, emits infrared LED light, and senses infrared LED light reflected by the peripheral object.

A camera subsystem 1093 may perform camera functions such as photographing and video clip recording.

The optical sensor 1092 may include a CCD (charged coupled device) or a CMOS (complementary metal-oxide semiconductor) device.

A communication function is performed through one or more wireless communication subsystems 1030 and 1031. The wireless communication subsystems 1030 and 1031 may include a radio frequency (RF) receiver and transmitter (or transceiver) and/or an optical (e.g., infrared) receiver and transmitter (or transceiver). The first wireless communication subsystem 1030 and the second wireless communication subsystem 1031 may be divided according to communication networks through which the electronic device 1000 communicate. For example, the electronic device 1200 may include, but is not limited to, communication subsystems operated through a GSM (Global System for Mobile Communication) network, an EDGE (Enhanced Data GSM Environment) network, a CDMA (Code Division Multiple Access) network, a W-CDMA (W-Code Division Multiple Access) network, an LTE (Long Term Evolution) network, an OFDMA (Orthogonal Frequency Division Multiple Access) network, a WiFi (Wireless Fidelity) network, a WiMax network, and/or a Bluetooth network, just to name a few non-limiting possibilities. The first wireless communication subsystem 1030 and the second wireless communication subsystem 1031 may be integrated into one wireless communication subsystem.

The audio subsystem 1050 is connected to the speaker 1051 and the microphone 1052 and includes circuitry to perform audio stream input/output functions such as voice recognition, voice replication, digital recording, and phone functions. That is, the audio subsystem 1050 communicates with the user through the speaker 1051 and the microphone 1052. The audio subsystem 1050 receives a data stream through the peripheral interface 1023 of the processor unit 1020 and converts the received data stream into an electric stream. The electric stream is transmitted to the speaker 1051. The speaker 1051 converts the electric stream into sound waves audible by humans and outputs the same. The microphone 1052 converts sound waves received from humans or other sound sources into an electric stream. The audio subsystem 1050 receives an electric stream converted from the microphone 1052. The audio subsystem 1050 converts the received electric stream into an audio data stream and transmits the audio data stream to the peripheral interface 1023. The audio subsystem 1050 may include an attachable/detachable earphone, a headphone, or a headset.

The I/O system 1070 may include a touchscreen controller 1071 and/or another input controller 1072 that includes a processor, microprocessor or microcontroller. The touchscreen controller 1071 may be connected to the touchscreen 1080. For example, the touchscreen 1080 and the touchscreen controller 1071 may detect a touch, a motion, or a stop thereof by using multi-touch detection technologies including a proximity sensor array or other elements, as well as capacitive, resistive, infrared and surface acoustic wave technologies for determining one or more touch points with the touchscreen 1080. The other input controller 1072 may be connected to the other input/control devices 1090. The other input/control device 1090 may include one or more buttons, a rocker switch, a thumb wheel, a dial, a stick, and/or a pointer device such as a stylus.

The touchscreen 1080 provides an I/O interface between the electronic device 1000 and the user. That is, the touchscreen 1080 transmits a user touch input to the electronic device 1000. Also, the touchscreen 1280 is a medium that displays an output from the electronic device 1000 to the user. That is, the touchscreen 1080 displays a visual output to the user. The visual output may be represented by a text, a graphic, a video, or a combination thereof.

The touchscreen 1080 may use various display technologies. For example, the touchscreen 760 may use an LCD (liquid crystal display), an LED (Light Emitting Diode), an LPD (light emitting polymer display), an OLED (Organic Light Emitting Diode), an AMOLED (Active Matrix Organic Light Emitting Diode), or an FLED (Flexible LED), or any other type of thin-film technology (TFT) device.

The memory 1010, which is a non-transitory machine readable medium, may be connected to the memory interface 1021. The memory unit 1010 may include one or more high-speed random-access memories (RAMs) such as magnetic disk storage devices, one or more nonvolatile memories, one or more optical storage devices, and/or one or more flash memories (e.g., NAND flash memories or NOR flash memories).

The memory unit 1010 stores machine executable code. Elements of the machine executable code include an operation system (OS) module 1011, a communication module 1012, a graphic module 1013, a user interface (UI) module 1014, a codec module 1015, a camera module 1016, and one or more application modules 1017. Since the module that is an element of the software may be represented as a set of instructions, the module may be referred to as an instruction set. The module may also be referred to as a program. The OS module 1011 (e.g., WINDOWS, LINUX, Darwin, RTXC, UNIX, OS X, or an embedded OS such as VxWorks) includes various software elements for controlling general system operations. For example, general system operation controls include memory control/management, storage hardware (device) control/management, and power control/management. The OS software also performs a function for enabling smooth communication between various hardware elements (devices) and software elements (modules). None of the module are software per se, as all are stored on non-transitory machine readable mediums and executed by hardware such as a processor or microprocessor.

The communication module 1012 may enable communication with other electronic devices (such as computers, servers, and/or portable terminals) through the wireless communication subsystems 1030 and 1031 or the external port 1060.

The graphic module 1013 includes various software elements that can be executed by circuitry such as a graphics processor for providing and displaying graphics on the touchscreen 1080. The graphics include texts, web pages, icons, digital images, videos, and animations. In the present invention, the touchscreen 1080 displays a message about whether a smart rotation function is set, and receives a selection of a region included in the message.

The UI module 1014 includes various software elements comprising machine executable code related to a user interface circuitry. Specifically, the UI module includes information about how the state of a user interface changes and/or information about under what condition the state of a user interface changes.

The codec module 1015 may include software elements comprising machine executable code related to video file encoding/decoding. The codec module 1215 may include a video stream module such as an MPEG module or an H204 module. Also, the codec module 1015 may include various audio file codec modules such as AAA, AMR, and WMA. Also, the codec module 1015 includes an instruction set corresponding to the implementation methods of the present invention and is loaded into hardware for execution by, for example, a processor or microprocessor.

The camera module 1016 may include camera-related software elements along with structure of a camera (lenses, CCDs, CMOS, etc.) that enable camera-related processes and functions.

The application module 1017 includes machine executable code that is loaded into a processor or microprocessor for execution to operate, for example, a browser application, an e-mail application, an instant message application, a word processing application, a keyboard emulation application, an address book application, a touch list application, a widget application, a digital right management (DRM) application, a voice recognition application, a voice replication application, a position determining function application, a location-based service (LBS) application, and the like.

In addition, various functions of the electronic device 1000 according to the present invention, which have been described above and will be described below, may be implemented by any combination of hardware and/or software executed by hardware including one or more stream processings and/or an application-specific integrated circuit (ASIC).

According to the electronic device and method of the present invention for blocking echo generation by eliminating a sound output from the speaker, an echo that may be output through the speaker can be blocked by controlling the operation of the second microphone through the optical proximity sensor.

The above-described apparatus and a method of operation according to the present invention can be implemented in hardware, and in part as firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

The terms “unit” or “module” as referred to herein is to be understood as constituting hardware such as a processor or microprocessor configured for a certain desired functionality, or a non-transitory medium comprising machine executable code, in accordance with statutory subject matter under 35 U.S.C. §101 and does not constitute software per se.

While the invention has been shown and described with reference to certain exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for operating an electronic device including a first microphone and a second microphone, comprising:
determining by a processor of the electronic device whether a sensor located within a predetermined range from the second microphone has sensed a peripheral object;
blocking by the processor an operation of the second microphone when the sensor has sensed a peripheral object; and
blocking by the processor echo generation by eliminating a sound that is output from a speaker and input to the first microphone.

2. The method according to claim 1, blocking by the processor an operation of the second microphone comprises reducing power supplied to the second microphone for operation while the first microphone and the loudspeaker remain operational.

3. The method according to claim 1, blocking by the processor an operation of the second microphone comprises disabling an interface that couples the second microphone to the processor.

4. The method of claim 1, further comprising confirming that the electronic device is operating in any one of a first mode or a second mode.

5. The method of claim 4, wherein the first mode comprises a loudspeaker mode.

6. The method of claim 4, wherein the second mode comprises a Video Telephony (VT) mode.

7. The method of claim 1, wherein the sensor comprises an optical proximity sensor.

8. The method of claim 1, wherein determining whether the sensor located within a predetermined range from the second microphone has sensed a peripheral object comprises:
emitting infrared Light Emitting Diode (LED) light by the sensor; and
determining whether the sensor has sensed the emitted infrared LED light that has reflected off the peripheral object.

9. The method of claim 1, wherein blocking the operation of the second microphone when the sensor has sensed a peripheral object comprises:
sensing infrared LED light reflected off the peripheral object; and
disabling the second microphone that is operating.

10. The method of claim 1, further comprising confirming that only the first microphone is operational after disabling the second microphone.

11. The method of claim 1, wherein blocking the echo generation by eliminating a sound output from a speaker and input to the first microphone comprises:
detecting that the sound output from the speaker is input to the first microphone; and
eliminating the sound before the sound input to the first microphone is output through the speaker.

12. The method of claim 11, wherein the echo is a sound that is generated when the sound output from the speaker and input to the first microphone and is again output through the speaker.

13. The method of claim 1, wherein the electronic device comprises a mobile communication terminal including a wireless communication subsystem, and wherein the sensor senses the mobile communication terminal being held as the sensed peripheral object.

14. The method of claim 1, wherein the electronic device comprises a mobile communication terminal including a wireless communication subsystem, and wherein the sensor senses the mobile communication terminal being disposed on an exterior surface as the sensed peripheral object.

15. An electronic device including a first microphone and a second microphone, comprising:
a sensor located within a predetermined range from the second microphone to sense a peripheral object; and
a processor unit for controlling a blocking of echo generation by eliminating a sound that is output from a speaker and input to the first microphone and disabling operation of the second microphone in response to the sensor having sensed the peripheral object.

16. The electronic device of claim 15, wherein the processor unit confirms that the electronic device is operating in any one of a first mode or a second mode.

17. The electronic device of claim 16, wherein the first mode comprises a loudspeaker mode.

18. The electronic device of claim 16, wherein the second mode comprises a Video Telephony (VT) mode.

19. The electronic device of claim 15, wherein the sensor comprises an optical proximity sensor.

20. The electronic device of claim 15, wherein the sensor emits infrared LED light and senses infrared LED light reflected off the peripheral object.

21. The electronic device of claim 15, wherein the sensor senses infrared LED light reflected by the peripheral object, and in response the processor unit disables operation of the second microphone.

22. The electronic device of claim 15, wherein the processor unit confirms that only the first microphone is operating.

23. The electronic device of claim 15, wherein the first microphone receives an input of the sound output from the speaker, and the processor unit eliminates the sound before the sound input to the first microphone is output through the speaker.

24. The electronic device of claim 23, wherein the echo comprises a sound that is generated when the sound output from the speaker and input to the first microphone is again output through the speaker.

25. The electronic device according to claim 15, comprising a mobile communication terminal having a wireless communication transceiver, and wherein the sensor senses the mobile communication terminal being held as the sensed peripheral object.

26. The electronic device according to claim 15, comprising a mobile communication terminal having a wireless communication transceiver, and wherein the sensor senses the mobile communication terminal being disposed on an exterior surface as the sensed peripheral object.
